(19) United States
(12) Patent Application Publication
(10) Pub. No.: US 2008/0044177 A1
(43) Pub. Date: Feb. 21, 2008

(54) METHOD FOR DETECTING UPSTREAM TIMESLOT CONFLICT IN PASSIVE OPTICAL NETWORK AND OPTICAL LINE TERMINAL THEREIN

(75) Inventors: Wei HUANG, Shenzhen (CN); Jun ZHAO, Shenzhen (CN); Fan YU, Shenzhen (CN); Wei LIN, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen, Guangdong (CN)

(21) Appl. No.: 11/834,340

(22) Filed: Aug. 6, 2007

(30) Foreign Application Priority Data
Aug. 16, 2006 (CN) 200610111403.9

(51) Int. Cl. H04B 10/08

(52) U.S. Cl. 398/15; 398/10

(57) ABSTRACT

Embodiments of the present invention disclose a method for detecting an upstream timeslot conflict in a Passive Optical Network (PON). An Optical Line Terminal (OLT) detects a timeslot conflict in an upstream timeslot. An OLT is provided also, including an optical receiver, an optical transmitter, a control unit and a detection unit. The detection unit receives an optical signal from the optical receiver, samples instantaneous optical power of the optical signal in an upstream timeslot, compares the instantaneous optical power with normal upstream optical power of the upstream timeslot, and detects that a timeslot conflict occurs in the upstream timeslot when the instantaneous optical power exceeds normal upstream optical power of the upstream timeslot. Embodiments of the present invention make the costs lower to detect an upstream timeslot conflict in the PON.

This application claims priority to Chinese Patent Application No. 200610111403.9, filed Aug. 16, 2006, which is hereby incorporated by reference.

### FIELD OF THE TECHNOLOGY

The present invention relates to passive optical network technologies, and particularly, to a method for detecting an upstream timeslot conflict in a passive optical network and an optical line terminal therein.

### BACKGROUND OF THE INVENTION

The Passive Optical Network (PON) technology is an optical access technology with Point to Multi-Point topology and the structure of a PON is shown in FIG. 1. The PON mainly includes three parts, an Optical Line Terminal (OLT), an Optical Distribution Network (ODN), and an Optical Network Unit (ONU). An OLT may be connected to one or more ODNs, and an ODN may further be connected to one or more ONUs. The ODN is configured for transmitting downstream data of the OLT to each of the ONUs through the optical splitter and transmitting converged upstream data of the ONUs to the OLT. The ONU is also called an Optical Network Terminal (ONT) if the ONU can provide customer-side interface, such as Ethernet interface or Plain Old Telephone Service (POTS) interface. Both an ONU and an ONT are uniformly referred to as an ONT for convenience.

FIG. 2 is a schematic diagram illustrating the transmission of downstream data in a PON, and FIG. 3 is a schematic diagram illustrating the transmission of upstream data in a PON. In general, the downstream data of the OLT are broadcasted to the ONTs in Time Division Multiplex (TDM) mode and each of the ONTs receives a special part of the downstream data based on an identifier. The upstream data of an ONT are transmitted to the OLT in Time Division Multiplex Address (TDMA) mode, and particularly, each of the ONTs transmits its upstream optical bursts during the timeslot allocated to itself.

A timeslot conflict will occur in the upstream timeslot in the case that an ONT in the PON is in failure, that is, the laser is turned on to send optical signals out of the timeslot allocated to the ONT. As shown in FIG. 4, for example, an optical signal from the ONT in failure may be overlapped with an optical signal from another ONT functioning normally. Thus, the OLT cannot correctly parse the upstream data sent by the ONT functioning normally. In addition, in the case that an ONT has emitted lights for a long time, none of the users supported in the same physical interface in the PON can normally work and thus the PON crashes. Therefore, for the network reliability, it is particularly important to detect an upstream timeslot conflict in the PON.

The conventional method for detecting the upstream timeslot conflict is implemented by adding a protection circuit in the ONT. The protection circuit monitors an optical transmitter and an optical transmitter controller of the ONT. The optical transmitter controller provides an enabling signal to the optical transmitter, and the enabling signal is valid in an upstream timeslot of the ONT and thus the optical transmitter emits lights. The protection circuit will send a failure indication signal and turn off the optical transmitter once the emitting duration of the optical transmitter is longer than a timeslot allocated by the OLT to the optical transmitter, or the valid duration of the enabling signal sent by the optical transmitter controller is longer than the timeslot allocated by the OLT to the optical transmitter.

However, because one OLT may be connected to multiple ODNs and one ODN may also be connected to multiple ONTs, there is a large number of ONTs. If each of the ONTs is configured with the protection circuit, the cost of the PON is increased greatly, the operation and maintenance of the PON are inconvenient. In addition, when a failure is detected by an ONT itself, the ONT turns off the optical transmitter automatically when detecting a failure. In such a case, the OLT cannot determine the reason why no upstream data of the ONT is transmitted, which increases the complexity of the operation and maintenance of the PON to some extent.

### SUMMARY OF THE INVENTION

Embodiments of the present invention provide a method for detecting an upstream timeslot conflict in a PON, an OLT and a detection unit.

A method for detecting an upstream timeslot conflict in a Passive Optical Network (PON) includes: detecting, by an Optical Line Terminal (OLT), a timeslot conflict in an upstream timeslot.

The detecting a timeslot conflict in an upstream timeslot includes:

sampling, by the OLT, instantaneous optical power of the upstream timeslot; and

detecting that the timeslot conflict occurs in the upstream timeslot when determining that the instantaneous optical power exceeds normal upstream optical power of the upstream timeslot.

Preferably, the method further includes: determining, by the OLT, an ONT in failure upon detecting that the timeslot conflict occurs in the upstream timeslot.

An Optical Line Terminal (OLT) includes at least one component for detecting a timeslot conflict in an upstream timeslot.

The at least one component includes: an optical receiver for receiving an optical signal; an optical transmitter for transmitting an optical signal; a control unit for managing the optical receiver and the optical transmitter; and a detection unit for receiving the optical signal from the optical receiver, sampling instantaneous optical power of the optical signal in an upstream timeslot, and detecting that the timeslot conflict occurs in the upstream timeslot when determining that the instantaneous optical power exceeds normal upstream optical power of the upstream timeslot.

A detection unit for detecting an upstream timeslot conflict includes one or more components for receiving an optical signal, sampling instantaneous optical power of the optical signal in an upstream timeslot, and detecting that a timeslot conflict occurs in the upstream timeslot when determining that the instantaneous optical power exceeds normal upstream optical power of the upstream timeslot.

As can be seen from the above, it is realized to detect at an OLT whether a timeslot conflict occurs in an upstream timeslot without adding a protection circuit to each ONT, the cost of detecting an upstream timeslot conflict is thus reduced. Moreover, upon detecting that a timeslot conflict occurs in an upstream timeslot, the OLT may determine which ONT is in failure and take measures to prevent the timeslot conflict from occurring again, thus the operation and maintenance of the system is convenient.

### BRIEF DESCRIPTION OF THE DRAWINGS

FIG. 1 is a schematic diagram illustrating the structure of a PON.

FIG. 2 is a schematic diagram illustrating downstream data transmission in a PON.

FIG. 3 is a schematic diagram illustrating upstream data transmission in a PON.

FIG. 4 is a schematic diagram illustrating an upstream timeslot conflict in a PON.

FIG. 5 is a flowchart illustrating a method for detecting an upstream tineslot conflict in accordance with an embodiment of the present invention.

FIG. 6 is a schematic diagram illustrating the structure of an OLT in accordance with an embodiment of the present invention.

FIG. 7 is a schematic diagram illustrating the structure of a detection unit in accordance with an embodiment of the present invention.

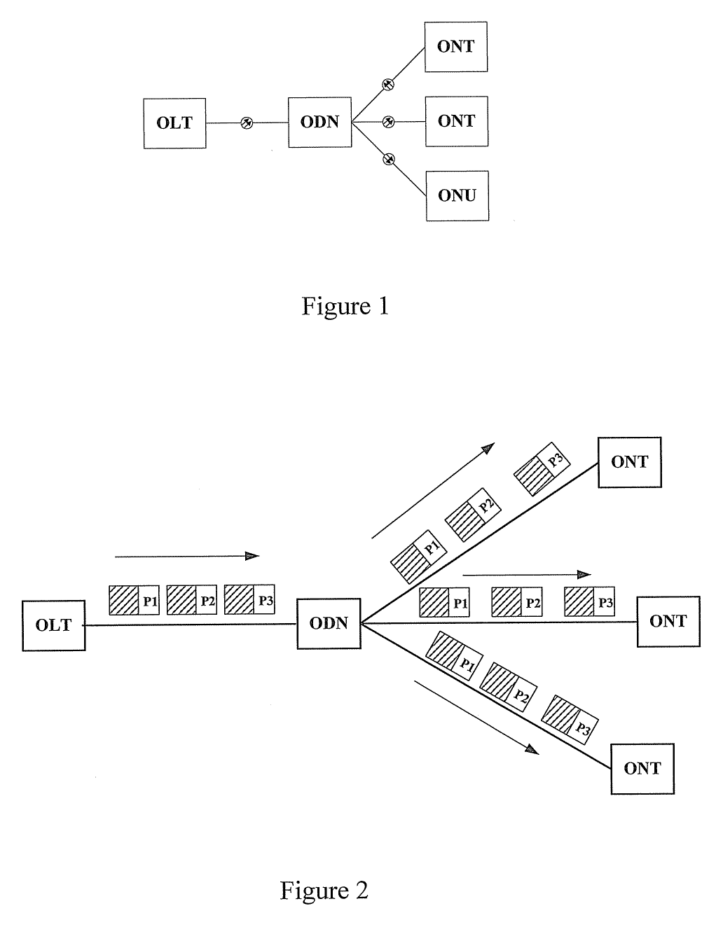

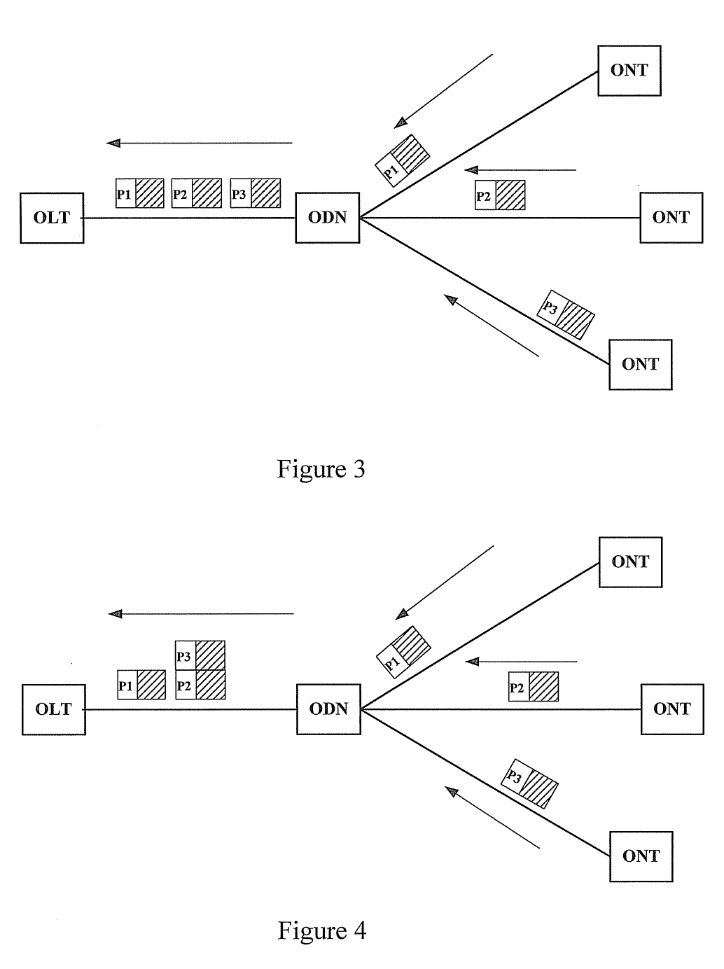

### EMBODIMENTS OF THE INVENTION

Embodiments of the present invention are hereinafter described in detail with reference to the drawings.

According to the embodiments of the present invention, an OLT detects whether a timeslot conflict occurs in an upstream timeslot.

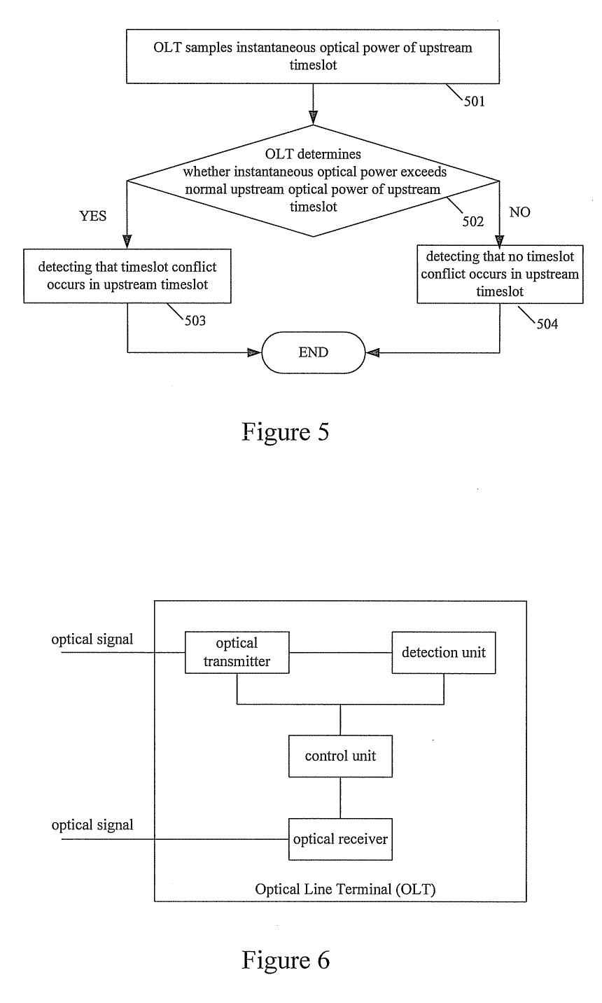

FIG. 5 is a flowchart illustrating a method for detecting an upstream timeslot conflict in accordance with an embodiment of the present invention. As shown in FIG. 5, the method for detecting an upstream tineslot conflict is described below.

Block 501: the OLT samples instantaneous optical power of an upstream timeslot.

Block 502: the OLT determines whether the instantaneous optical power exceeds normal upstream optical power of the upstream timeslot; if yes, Block 503 is performed; otherwise, Block 504 is performed.

Block 503: the OLT determines that a timeslot conflict occurs in the upstream timeslot and the process is terminated.

Block 504: the OLT determines that no timeslot conflict occurs during the upstream timeslot.

The sampling in Block 501 may be periodical sampling and the sampling period may be set according to practical conditions. For example, the sampling period is set as several bits. With respect to an upstream timeslot, the OLT may determine that a timeslot conflict occurs in the upstream timeslot when the OLT determines that the instantaneous optical power exceeds the normal upstream optical power of the upstream timeslot one time. However, to guarantee the accuracy of determining whether a timeslot conflict occurs in the upstream timeslot, the OLT may set a threshold in advance, e.g. set the threshold as three times. With respect to an upstream timeslot, the OLT determines whether the number of times the instantaneous optical power exceeds the normal upstream optical power of the upstream timeslot reaches the threshold. If it dose, the OLT determines that a timeslot conflict occurs in the upstream timeslot; otherwise, determines that no timeslot conflict occurs during the upstream timeslot

There are two cases in the determination in Block 502.

In a case that the upstream timeslot of which the instantaneous optical power is sampled is an upstream timeslot allocated to an ONT, the OLT determines whether the instantaneous optical power exceeds the normal upstream optical power of the ONT; if yes, the OLT determines that a timeslot conflict occurs in the upstream timeslot of the ONT, otherwise, determines that no timeslot conflict occurs in the upstream timeslot of the ONT.

In the meantime, the OLT stores normal upstream optical power of each ONT in advance, and the normal upstream optical power of each ONT can be measured by the OLT. Upon obtaining instantaneous optical power through sampling in an upstream timeslot allocated to an ONT, the OLT searches for the normal upstream optical power of the ONT and compares the instantaneous optical power with the normal upstream optical power of the ONT.

In another case that the upstream timeslot is an upstream timeslot that is not allocated to any ONT, the OLT determines whether the instantaneous optical power exceeds the optical power when no optical signal is transmitted. In other words, for an upstream timeslot that is not allocated to any ONT, the OLT detects whether there is instantaneous optical power in the upstream timeslot. If there is instantaneous optical power in the upstream timeslot, the OLT determines that a timeslot conflict occurs in the upstream timeslot, otherwise, determines that no timeslot conflict occurs in the upstream timeslot.

The OLT may update the normal upstream optical power of an upstream timeslot in real time during ranging procedure or when an ONT functions normally.

Moreover, upon detecting a timeslot conflict, the OLT may further determine which ONT is in failure. In other words, the OLT may determine which ONT turns on the optical transmitter in the timeslot that is not allocated to the ONT and causes a timeslot conflict. There are many methods for the OLT to determine which ONT is in failure. For example, the ONT corresponding to the upstream timeslot in which a timeslot conflict occurs and the ONTs corresponding to upstream timeslots adjacent to the upstream timeslot are included into one group, the upstream data transmission of the ONTs in the group is stopped one by one. If there is no timeslot conflict occurs any more when a certain ONT stops transmitting upstream data, the ONT stopping transmitting upstream data is determined as the ONT in failure. For another example, the OLT exchanges the relative position of the upstream timeslot of the ONT in which the conflict timeslot occurs with the relative position of an upstream timeslot of an ONT adjacent to the upstream timeslot in which the conflict timeslot occurs, and determines that the ONT corresponding to an upstream timeslot in which a timeslot conflict still occurs after the exchanging is the ONT in failure.

Upon determining the ONT in failure, the OLT takes measures to prevent the timeslot conflict from occurring again, for example, turning off the optical transmitter of the ONT in failure or recovering the ONT in failure to a normal state so as to prevent the ONT in failure from affecting the upstream data transmission of the other ONTs functioning normally in the PON.

FIG. 6 is a schematic diagram illustrating the structure of an OLT in accordance with an embodiment of the present invention. As shown in FIG. 6, an OLT generally includes an optical receiver for receiving an optical signal, an optical transmitter for transmitting an optical signal, and a control unit for managing the optical receiver and the optical transmitter. The OLT corresponding to the method provided in the embodiments of the present invention further includes a detection unit. The detection unit receives the optical signal from the optical receiver, samples instantaneous optical power of the optical signal in an upstream timeslot, and compares the instantaneous optical power sampled with the normal upstream optical power of the upstream timeslot.

In the case that the instantaneous optical power exceeds the normal upstream optical power, the detection unit sends a timeslot conflict indication to the control unit.

The control unit generates an enabling signal for managing the detection unit to sample instantaneous optical power, and the enabling signal may be a periodic pulse signal with the period of several bits and is valid in an upstream timeslot.

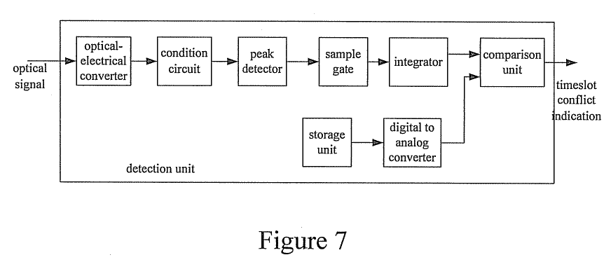

FIG. 7 is a schematic diagram illustrating the structure of a detection unit in accordance with an embodiment of the present invention. As shown in FIG. 7, the detection unit includes an optical-electrical converter, a condition circuit, a peak detector, a sample gate, an integrator, a comparison unit, a storage unit and a digital to analog converter.

The optical-electrical converter receives an optical signal from the optical receiver, converts the optical signal into a current signal, and sends the current signal to the condition circuit. The optical-electrical converter may be an optoelectronic diode.

The condition circuit receives the current signal from the optical-electrical converter, converts the current signal into a voltage signal, and sends the voltage signal to the peak detector. The condition circuit may be a transimpedance amplifier.

The peak detector receives the voltage signal from the condition circuit, extracts the peak voltage of the voltage signal, and sends the peak voltage to the sample gate. The peak detector may be a half-wave rectifier.

The sample gate receives the peak voltage from the peak detector, samples and locks the peak voltage to obtain a sample signal, for example, samples the peak voltage under the control of an enabling signal generated by the control unit, and sends the sample signal obtained to the integrator, thus realizing instantaneous sampling of the upstream optical signal. The sample gate may include a field effect transistor

The integrator receives the sample signal from the sample gate, charges a Resistor-Capacitor (RC) time constant integrator with the sample signal, the output of the integrator is the optical power when the enabling signal is valid. In other words, the integrator integrates the sample signal to obtain the instantaneous optical power of an allocated upstream timeslot, and sends the instantaneous optical power to the comparison unit.

The comparison unit receives the instantaneous optical power from the integrator and compares the instantaneous optical power with the normal upstream optical power of the ONT corresponding to the allocated upstream timeslot in which the sampling is performed.

In the case that the instantaneous optical power exceeds the normal upstream optical power, the comparison unit sends a timeslot conflict indication to the control unit.

The storage unit stores the normal upstream optical power of an ONT, and the storage unit may be a Read Only Memory (ROM) or an Electrically Erasable Programmable Read-Only Memory (EEPROM).

Since normal upstream optical power stored in the storage unit is in the digital form, the normal upstream optical power should be converted into the one in the analog form by the digital to analog converter before the comparison unit performs a comparison, and the digital to analog converter sends to the comparison unit the converted normal upstream optical power.

The control unit may take measures to prevent a timeslot conflict from occurring again upon detecting the timeslot conflict.

As can be seen from above that it may be implemented with a low cost of the detection unit to detect an upstream timeslot conflict according to the embodiments of the present invention.

To sum up, the forgoing are only embodiments of the present invention but not for use in limiting the present invention. Any modification, equivalent substitution, improvement within the spirit and principle of the present invention should be covered in the protection scope of the present invention.

What is claimed is:

1. A method for detecting an upstream timeslot conflict in a Passive Optical Network (PON), comprising:
detecting, by an Optical Line Terminal (OLT), a timeslot conflict in an upstream timeslot.

2. The method of claim 1, wherein the detecting a timeslot conflict in an upstream timeslot comprises:
sampling, by the OLT, instantaneous optical power of the upstream timeslot;
detecting that the timeslot conflict occurs in the upstream timeslot when determining that the instantaneous optical power exceeds normal upstream optical power of the upstream timeslot.

3. The method of claim 2, wherein the upstream timeslot is an upstream timeslot allocated to an Optical Network Terminal (ONT);
the normal upstream optical power of the upstream timeslot is normal upstream optical power of the ONT.

4. The method of claim 2, wherein the upstream timeslot is an upstream timeslot that is not allocated to an ONT;
the normal upstream optical power of the upstream timeslot is optical power when no optical signal is transmitted in the upstream timeslot.

5. The method of claim 2 wherein the sampling the instantaneous optical power of the upstream timeslot comprises:
sampling the instantaneous optical power of the upstream timeslot periodically.

6. The method of claim 5, wherein the detecting that the timeslot conflict occurs in the upstream timeslot comprises:
detecting that the timeslot conflict occurs in the upstream timeslot when determining that the number of times the instantaneous optical power has exceeded the normal upstream optical power reaches a threshold.

7. The method of claim 3, further comprising:
storing, by the OLT, the normal upstream optical power of the ONT before determining that the instantaneous optical power exceeds the normal upstream optical power of the ONT.

8. The method of claim 2, further comprising:
determining, by the OLT, an ONT in failure upon detecting that the timeslot conflict occurs in the upstream timeslot.

9. The method of claim 8, wherein the determining an ONT in failure comprises:
including, by the OLT, an ONT corresponding to the upstream timeslot in which the timeslot conflict occurs and ONTs corresponding to upstream timeslots adjacent to the upstream timeslot in which the timeslot conflict occurs into a group;
stopping upstream data transmission of an ONT in the group; and
determining that the ONT of which the upstream data transmission is stopped is the ONT in failure if no timeslot conflict occurs in the upstream timeslot any more when the upstream data transmission of the ONT in the group is stopped.

10. The method of claim 8, wherein the determining an ONT in failure comprises:
exchanging, by the OLT, relative positions of upstream timeslots of ONTs, wherein the upstream timeslots of the ONTs comprise: the upstream timeslot in which the timeslot conflict occurs, and an upstream timeslot adjacent to the upstream timeslot in which the timeslot conflict occurs; and
determining an ONT corresponding to an upstream timeslot in which the timeslot conflict still occurs after the exchanging as the ONT in failure.

11. The method of claim 8, further comprising: turning off the ONT in failure.

12. The method of claim 8, further comprising: recovering the ONT in failure to a normal state.

13. The method of claim 2, further comprising:
updating, by the OLT, the normal upstream optical power of the upstream timeslot in real time during a ranging procedure or when an ONT functions normally.

14. An Optical Line Terminal (OLT), comprising at least one component for detecting a timeslot conflict in an upstream timeslot.

15. The OLT of claim 14, wherein the at least one component comprises:
an optical receiver for receiving an optical signal;
an optical transmitter for transmitting an optical signal;
a control unit for managing the optical receiver and the optical transmitter; and
a detection unit for receiving the optical signal from the optical receiver, sampling instantaneous optical power of the optical signal in an upstream timeslot, and detecting that the timeslot conflict occurs in the upstream timeslot when determining that the instantaneous optical power exceeds normal upstream optical power of the upstream timeslot.

16. The OLT of claim 15, wherein the detection unit is further configured for sending a timeslot conflict indication to the control unit when determining that the instantaneous optical power exceeds the normal upstream optical power of the upstream tineslot.

17. The OLT of claim 15, wherein the control unit is further configured for generating an enabling signal for managing the detection unit to sample the instantaneous optical power of the optical signal in the upstream timeslot.

18. The OLT of claim 15, wherein the detection unit comprises:
an optical-electrical converter for receiving the optical signal from the optical receiver, converting the optical signal into a current signal, and sending the current signal;
a condition circuit for receiving the current signal from the optical-electrical converter, converting the current signal into a voltage signal, and sending the voltage signal;
a peak detector for receiving the voltage signal from the condition circuit, extracting a peak voltage of the voltage signal received, and sending the peak voltage;
a sample gate for receiving the peak voltage from the peak detector, sampling and locking the peak voltage to obtain a sample signal, and sending the sample signal;
an integrator for receiving the sample signal from the sample gate, integrating the sample signal to obtain the instantaneous optical power of the upstream timeslot, and sending the instantaneous optical power;
a comparison unit for receiving the instantaneous optical power from the integrator, comparing the instantaneous optical power with the normal upstream optical power of the upstream timeslot, and detecting that the timeslot conflict occurs in the upstream timeslot when the instantaneous optical power exceeds the normal upstream optical power of the upstream timeslot;
a storage unit for storing the normal upstream optical power of an Optical Network Terminal (ONT) and sending the normal upstream optical power of the ONT;
a digital to analog converter for converting the normal upstream optical power from the storage unit into normal upstream optical power in an analog form and sending the converted normal upstream optical power to the comparison unit.

19. The OLT of claim 18, wherein the comparison unit is further configured for sending a timeslot conflict indication to the control unit when the instantaneous optical power exceeds the normal upstream optical power of the upstream timeslot.

20. A detection unit for detecting an upstream timeslot conflict, comprising one or more components for
receiving an optical signal,
sampling instantaneous optical power of the optical signal in an upstream timeslot, and
detecting that a timeslot conflict occurs in the upstream timeslot when determining that the instantaneous optical power exceeds normal upstream optical power of the upstream timeslot.

21. The detection unit of claim 20, wherein the one or more components comprise:
an optical-electrical converter for receiving the optical signal, converting the optical signal into a current signal, and sending the current signal;
a condition circuit for receiving the current signal from the optical-electrical converter, converting the current signal into a voltage signal, and sending the voltage signal;
a peak detector for receiving the voltage signal from the condition circuit, extracting a peak voltage of the voltage signal, and sending the peak voltage;
a sample gate for receiving the peak voltage from the peak detector, sampling and locking the peak voltage to obtain a sample signal, and sending the sample signal;
an integrator for receiving the sample signal from the sample gate, integrating the sample signal to obtain the instantaneous optical power of the upstream timeslot, and sending the instantaneous optical power;
a comparison unit for receiving the instantaneous optical power from the integrator, comparing the instantaneous optical power with the normal upstream optical power of the upstream timeslot, and detecting that the timeslot conflict occurs in the upstream timeslot when the instantaneous optical power exceeds the normal upstream optical power of the upstream timeslot;
a storage unit for storing normal upstream optical power of an Optical Network Terminal (ONT) and sending the normal upstream optical power of the ONT;
a digital to analog converter for converting the normal upstream optical power from the storage unit into normal upstream optical power in an analog form and sending the converted normal upstream optical power to the comparison unit.
